(19) United States
(12) Patent Application Publication
(10) Pub. No.: US 2016/0212102 A1
(43) Pub. Date: Jul. 21, 2016

(54) METHOD AND DEVICE FOR DISTRIBUTING TRAFFIC BY USING PLURALITY OF NETWORK INTERFACES IN WIRELESS COMMUNICATION SYSTEM

(71) Applicant: SAMSUNG ELECTRONICS CO., LTD., Suwon-si, Gyeonggi-do (KR)

(72) Inventors: Jiangwei XU, Suwon-si (KR); Yong-Seok PARK, Seoul (KR); Kang-Jin YOON, Seoul (KR)

(21) Appl. No.: 14/913,577

(22) PCT Filed: Aug. 20, 2014
(86) PCT No.: PCT/KR2014/007705

§ 371 Date: Feb. 22, 2016

(30) Foreign Application Priority Data
Aug. 20, 2013 (KR) 10-2013-0098452

(51) Int. Cl. H04L 29/06; H04W 76/02; H04W 12/08

(52) U.S. Cl. CPC H04L 63/0428; H04W 12/08; H04W 76/02; H04L 63/10

(57) ABSTRACT

A method and a device for distributing traffic by a terminal in a wireless communication system are provided. The method includes generating a first secure sockets layer (SSL) connection through a first network interface with a server that provides content based on hypertext transfer protocol security (HTTPS) if an HTTPS request is received from an application, generating a second SSL connection through a second network interface to the server based on information on the content, and receiving, through the first and second network interfaces, content data distributed and transmitted through the first and second SSL connections from the server.

### CROSS-REFERENCE TO RELATED APPLICATION(S)

This application is a U.S. National Stage application under 35 U.S.C. §371 of an International application filed on Aug. 20, 2014 and assigned application number PCT/KR2014/007705, which claimed the benefit of a Korean patent application filed on Aug. 20, 2013 in the Korean Intellectual Property Office and assigned Serial number 10-2013-0098452, the entire disclosure of which is hereby incorporated by reference.

### TECHNICAL FIELD

The present disclosure relates to a method and an apparatus for distributing traffic in a wireless communication system that supports a plurality of network interfaces.

### BACKGROUND

With the rapid increase in use of wireless networks, such as a Wi-Fi network to provide high-speed packet services, a 3^{rd} generation (3G) cellular communication system, or a cellular network (for example, a 4^{th} generation (4G) cellular communication system, such as long term evolution (LTE)), the data amount of content that is provided to user equipment (UE), such as a tablet and a smart phone, capable of using broadband multimedia services through a wireless network is also increasing sharply.

For example, high-quality video content that is provided through a wireless network is created with data of several hundreds of mega-bytes or several giga-bytes. Accordingly, in order to transmit high-quality video content through a wireless network, a high transfer rate is required.

The data amount of applications that are provided by a content provider, such as Google Play Store of Google or App Store of Apple, is generally very large so that one content reaches several giga-bytes. Accordingly, it is difficult to satisfy such a wireless data amount (or transfer rate) through carriers of a single Wi-Fi network or a single cellular network.

In a general wireless communication system, a terminal connects to a cellular network or a Wi-Fi network to use data services. However, the cellular network cannot cooperate with the Wi-Fi network, and also a terminal cannot connect to both the cellular network and the Wi-Fi network at the same time. Meanwhile, in the wireless communication system, download services that support well-known hypertext transfer protocol security (HTTPS) for security are increasingly used.

FIG. 1 illustrates protocol stacks of HTTP and HTTPS that are used in a wireless communication system according to the related art.

Referring to FIG. 1, an HTTP 110 is a request/response protocol that is used between a terminal and a server so that the terminal which is a client can transmit/receive information to/from the server on the world wide web (WWW). For example, if the terminal requests the server to transmit content through the HTTP 110, the server may transmit the requested content to the terminal, as an HTTP response responding to the HTTP request.

An HTTPS 130 further includes transport layer security (TLS)/secure sockets layer (SSL) 131 which is a well-known security protocol, compared to the HTTP 110. Since differences between TLS and SSL 131 as security protocols are irrelevant to the present disclosure which will be described below, HTTPS will be, for convenience of description, described based on SSL.

FIG. 2 illustrates a procedure for generating an HTTPS session in a wireless communication system according to the related art. Hereinafter, operation for generating an HTTPS session between a terminal 200 which is a client and a server 400 will be described with reference to FIG. 2.

Referring to FIG. 2, in operations 201 to 205, a transmission control protocol (TCP) session 21 is generated, and in operations 207 to 225, a TCP/SSL session 23 for security is generated, and an HTTP session (that is, an HTTPS session) 25 for transmitting an HTTP request/response is generated through the TCP/SSL session 23.

Operation of generating the TCP/SSL session 23 will be described below. In operation 207, the terminal 200 transmits a Client Hello message including the SSL version, encryption settings, and session-specific data of the terminal 200 and other information needed by the server 400, to the server 400.

In operation 209, the server 400 transmits a Server Hello message including the certificate, SSL version, encryption settings, and session-specific data of the server 400 and other information needed by the terminal 200, to the terminal 200.

In operation 211, the terminal 200 authenticates the server 400 using information received from the server 400 through the Server Hello message, and in operation 213, the terminal 200 generates a pre-master secret key for session.

In operation 215, the terminal 200 encrypts the pre-master secret key using a public key of the server 400, and transmits the encrypted pre-master secret key to the server 400. Thereafter, the server 400 decrypts the pre-master secret key received from the terminal 200 using a private key.

In operations 217a and 217b, the terminal 200 and the server 400 each generates a master secret key based on the pre-master secret key, and in operations 219a and 219b, the terminal 200 and the server 400 each generates a session key using the generated master secret key. The session key which is a symmetric key is used to encrypt/decrypt information that is exchanged between the terminal 200 and the server 400 during the SSL session.

In operations 221 and 223, the terminal 200 and the server 400 each transmits an encrypted handshake message indicating that its own handshake has completed.

In operation 225, the terminal 200 verifies a host name, and a TSL/SSL session is generated according to the procedure described above.

In operations 227, the terminal 200 transmits an HTTP request message to the server 400, and in operations 229, the server 400 transmits an HTTP response message to the terminal 200.

After an HTTP session (that is, an HTTPS session) using the transport layer security (TLS)/secure sockets layer (SSL) session is generated, requested content is downloaded through the generated hypertext transfer protocol security (HTTPS) session. This indicates that if an HTTPS session is generated, a terminal can use only one transmission control protocol (TCP) session (connection) in order to download requested content through the HTTPS session. Accordingly, when HTTPS is used, a terminal can download requested content through a wireless network for which an HTTPS session has been generated, but the content requested through the HTTPS session cannot use other wireless networks that the terminal supports.

For example, when the terminal requests HTTPS-based content and downloads the HTTPS-based content through a Wi-Fi network, the terminal cannot download the corresponding content through a cellular network, and vice versa. Accordingly, the HTTPS acts as a factor disabling traffic distribution technology in an HTTP-based network.

Therefore, a need exists for a method and an apparatus for distributing traffic in a wireless communication system that supports a plurality of network interfaces.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for enabling a terminal to distribute traffic using a plurality of network interfaces in a wireless communication system.

Another aspect of the present disclosure is to provide a method and an apparatus for distributing traffic in a wireless communication system that supports a plurality of network interfaces and HTTPS.

Another aspect of the present disclosure is to provide a terminal and method for using a plurality of network interfaces at the same time to download HTTPS-based content in a wireless communication system.

In accordance with an aspect of the present disclosure, a method of enabling a terminal to distribute traffic in a wireless communication system is provided. The method includes generating, if an HTTPS request is received from an application, a first SSL connection through a first network interface with a server that provides content based on HTTPS, generating a second SSL connection through a second network interface with the server, based on information about the content, and receiving data of content distributively transmitted through the first SSL connection and the second SSL connection from the server, through the first network interface and the second network interface.

In accordance with another aspect of the present disclosure, a terminal of distributing traffic in a wireless communication system is provided. The terminal includes a plurality of network interfaces configured to communicate with a plurality of wireless networks and a controller configured to control operation of generating, if an HTTPS request is received from an application, a first SSL connection through a first network interface with a server that provides content based on HTTPS, of generating a second SSL connection through a second network interface with the server based on information about the content, and of receiving data of content that is distributively transmitted through the first SSL connection and the second SSL connection from the server, through the first network interface and the second network interface.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates protocol stacks of hypertext transfer protocol (HTTP) and HTTP security (HTTPS) that are used in a wireless communication system according to the related art;

FIG. 2 illustrates a procedure for generating an HTTPS session in a wireless communication system according to the related art;

FIG. 3 illustrates a configuration of a terminal of using a plurality of network interfaces in a wireless communication system according to an embodiment of the present disclosure;

FIG. 4 is a flowchart illustrating a communication method of a terminal using a plurality of network interfaces in a wireless communication system according to an embodiment of the present disclosure;

FIGS. 5A and 5B are flowcharts illustrating a method of distributing traffic using a plurality of network interfaces in a wireless communication system according to various embodiments of the present disclosure; and

FIG. 6 is a flowchart illustrating a method of enabling a terminal to determine whether to use a plurality of network interfaces in a wireless communication system according to an embodiment of the present disclosure.

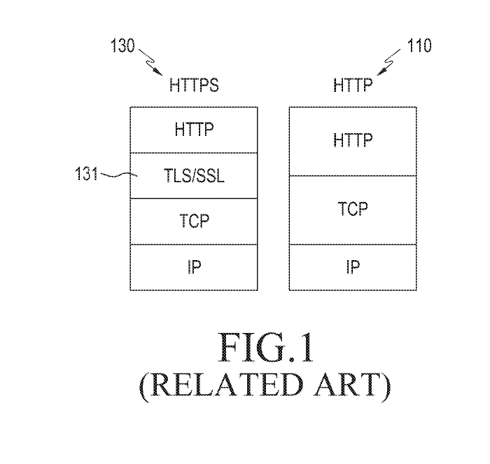

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

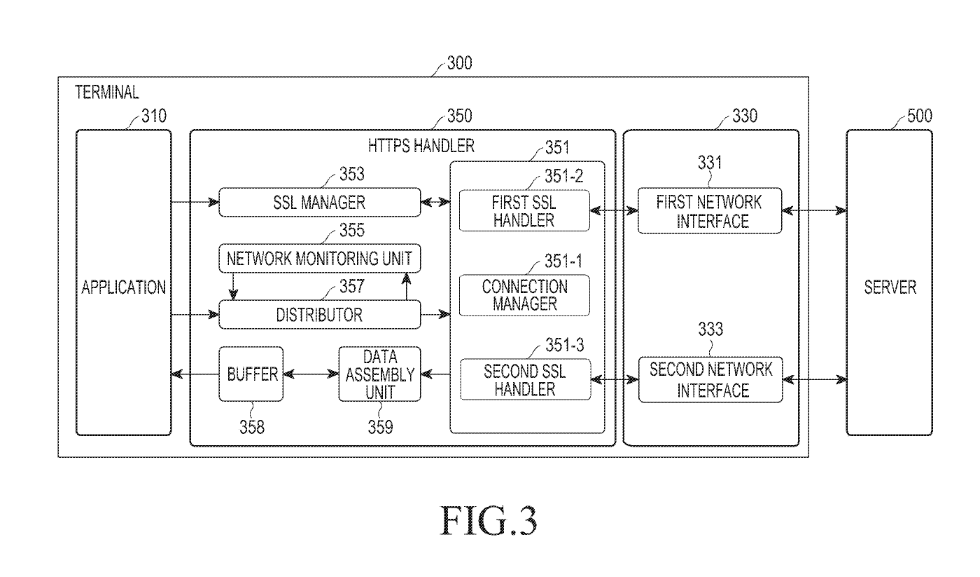

FIG. 3 illustrates a configuration of a terminal of using a plurality of network interfaces in a wireless communication system according to an embodiment of the present disclosure.

Referring to FIG. 3, a terminal 300 may include an application 310 configured to use a hypertext transfer protocol (HTTP)-based data service, a network interface unit 330 including a plurality of different network interfaces, and a controller 350 configured to generate a plurality of transmission control protocol (TCP) connections using the plurality of network interfaces to control operation of receiving HTTP security (HTTPS)-based content.

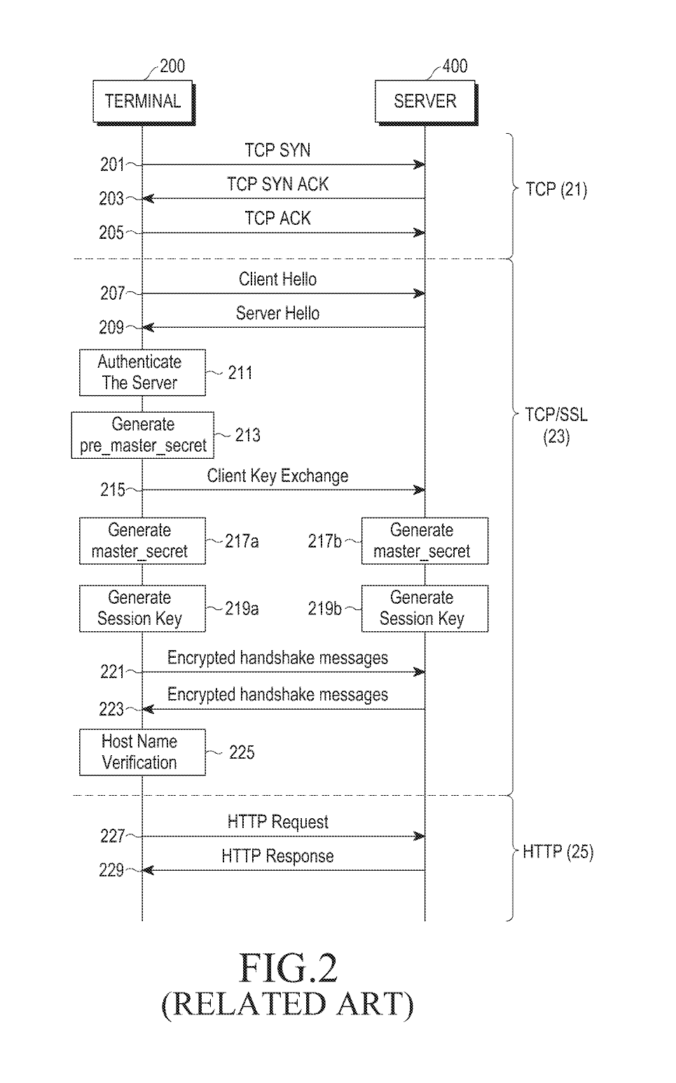

Referring to FIG. 3, the application 310 may set secure sockets layer (SSL)-related information required for generating an HTTPS session, wherein the SSL-related information may be, for example, various kinds of parameters that are used to generate a transmission security layer (TSL)/SSL session, and the parameters may be used to generate a pre-master secret key and a master key, as shown in FIG. 2. The application 310 may be one of various kinds of applications that use HTTPS. In addition, according to an embodiment of the present disclosure, the application 310 may be a typical application that uses HTTPS.

The network interface unit 330 may include a first network interface 331 configured to connect to a first wireless network, and a second network interface 333 configured to connect to a second wireless network that is different from the first wireless network. The first and second network interfaces 331 and 333 may support HTTP(S)-based TCP connections. For example, it is assumed that the first network interface 331 is configured to connect to a Wi-Fi network, and the second network interface 333 is configured to connect to a cellular network. However, the Wi-Fi network and the cellular networks are examples of networks capable of supporting TCP connections, and networks to which the present disclosure can be applied are not limited to the Wi-Fi network and the cellular network. In addition, in the current embodiment of the present disclosure, for convenience of description, the network interface unit 330 is assumed to include two network interfaces, however, the network interface unit 330 may include two or more different network interfaces that support TCP connections.

In the current embodiment of the present disclosure, the controller 350 may control communication through the network interface unit 330 according to operation of the application 310. If the controller 350 receives a request for downloading HTTPS-based content from the application 310, the controller 350 may generate a TCP connection and an SSL connection to a server 500 through the first and second network interfaces 331 and 333, respectively, and control operation of receiving traffic of content distributively transmitted upon downloading HTTPS-based content, simultaneously, through the first and second network interfaces 331 and 333. The server 500 may be a web server that provides world wide web (WWW)-based services.

Whether to simultaneously use the first and second network interfaces 331 and 333 may be decided based on a data amount of the content. If the controller 350 determines that the data amount of the content is greater than a threshold value, the controller 350 may perform control operation of distributing traffic through the first and second network interfaces 331 and 333, and if the controller 350 determines that the data amount of the content is less than or equal to the threshold value, the controller 350 may perform control operation of receiving the content through a network interface selected from between the first network interface 331 and the second network interface 333, similar to a method of the related art.

In addition, the current embodiment relates to an example of an HTTPS-based data service using SSL, however, the controller 350 can control the use of a plurality of network interfaces based on a data amount of content for other HTTP-based data services as well as the HTTPS-based data service, for example, in such a way to use the plurality of network interfaces if the data amount of the content is greater than a threshold value, and to use a single network interface if the amount of data of the content is less than or equal to the threshold value.

In addition, the controller 350 may be implemented as a processor that has an HTTP handler including a plurality of SSL handlers corresponding to a plurality of network interfaces in order to provide the HTTPS-based data service. The HTTPS handler may be embodied as a program, and in this case, the controller 350 may include the program and a microprocessor to drive the program.

In the embodiment of FIG. 3, the controller 350 may include an HTTPS handler for, for example, an HTTPS-based data service, and the HTTPS hander may include an HTTPS manager 351, an SSL manager 353, a network monitoring unit 355, a distributor 357, a buffer 358, and a data assembly unit 359.

If a network access request (for example, an HTTP request) for downloading content is received from the application 310, the distributor 357 may distribute the HTTP request to the first and second interfaces 331 and 333 of the network interface unit 330. At this time, the distributor 357 may decide whether to distributively process the HTTP request according to a data amount of the content. When traffic distribution is performed, the data assembly unit 359 may re-assemble data of content respectively received through the first and second network interfaces 331 and 333, and transfer the re-assembled data to the buffer 358.

The network monitoring unit 355 may detect data download speeds at the first and second network interfaces 331 and 333, and control download amounts and download speeds of the first and second network interfaces 331 and 333 based on the detected download speeds. According to an embodiment of the present disclosure, the network monitoring unit 355 may control download speeds of the first and second network interfaces 331 and 333, based on changes in transmission rate or load states of wireless networks to which the first and second network interfaces 331 and 333 are connected.

In the current embodiment of the present disclosure, when traffic of content that is downloaded is distributed, parts of content data that are to be distributively transmitted from the server 500 may be indicated through HTTP requests that are respectively transmitted to the server 500 through the first and second network interfaces 331 and 333.

In the embodiment of FIG. 3, the SSL manager 353 may receive SSL-related information (for example, various parameters to be used upon generating SSL sessions) from the application 310, set SSL parameters for the first and second network interfaces 331 and 333, respectively, and transfer the results of the settings to the HTTPS manager 351. The HTTPS manager 351 may process an HTTP request/response (for example, an HTTP HEAD request/response, an HTTP RANGE request/response, and the like) received from the distributor 357, and control generation of SSL connections (that is, SSL sessions) through the first and second network interfaces 331 and 333 using the SSL-related information received from the SSL manager 353.

The HTTPS manager 351 may include a connection manager 351-1 and first and second SSL handlers 351-2 and 351-3. The connection manager 351-1 may process the HTTP request/response between the distributor 357 and the server 500, and generate a TCP connection through the first and second network interfaces 331 and 333. The first SSL handler 351-2 may process SSL parameters for the first network interface 331 to generate a first SSL connection to the server 500, and may encrypt/decrypt data that is to be transmitted/received to/from the server 500 through the first network interface 331. The second SSL handler 351-3 may process SSL parameters for the second network interface 333 to generate a second SSL connection to the server 500, and may encrypt/decrypt data that is to be transmitted/received to/from the server 500 through the second network interface 333.

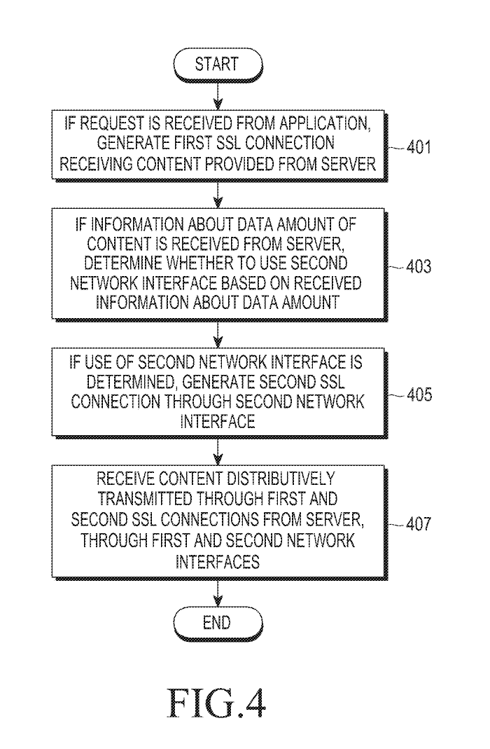

FIG. 4 is a flowchart illustrating a communication method of a terminal using a plurality of network interfaces in a wireless communication system according to an embodiment of the present disclosure.

Referring to FIG. 4, if an HTTPS request for secure downloading of content is received from the application 310, the terminal 300 may generate a first SSL connection through the first network interface 331 for secure reception of the content from the server 500 through a wireless network, in operation 401. The first SSL connection may be generated based on SSL-related information set by the application 310.

If information about a data amount of the content that is to be downloaded is received from the server 500, the terminal 300 may compare the received information about the data amount of the content to a threshold value to thus determine whether to use the second network interface 333, in operation 403. In operation 403, if the terminal 300 determines that the data amount of the content is greater than the threshold value, the terminal 300 may determine that the content should be downloaded using both the first and second network interfaces 331 and 333, and if the terminal 300 determines that the data amount of the content is less than or equal to the threshold value, the terminal 300 may determine that the content should be downloaded without using the second network interface 333.

If the terminal 300 determines in operation 403 that the content should be downloaded using both the first and second network interfaces 331 and 333, the terminal 300 may generate a second SSL connection through the second network interface 333, in operation 405. The second SSL connection may be generated based on the SSL-related information provided from the application 310.

In operation 407, the terminal 300 may receive data of the content secured (that is, encrypted) and distributively transmitted through the first and second SSL connections from the server 500, through the first and second network interfaces 331 and 333. Herein, an amount and range of data that is distributively transmitted may be designated through message exchange between the terminal 300 and the server 500, and the amount and range of data may be changed through network monitoring of the terminal 300. The network monitoring may be performed periodically or based on network load.

FIG. 4 relates to an example of determining whether to use the second network interface 333 based on the data amount of content. However, it is also possible to use a plurality of available network interfaces or a plurality of network interfaces when downloading HTTPS-based content, without considering the data amount of the content.

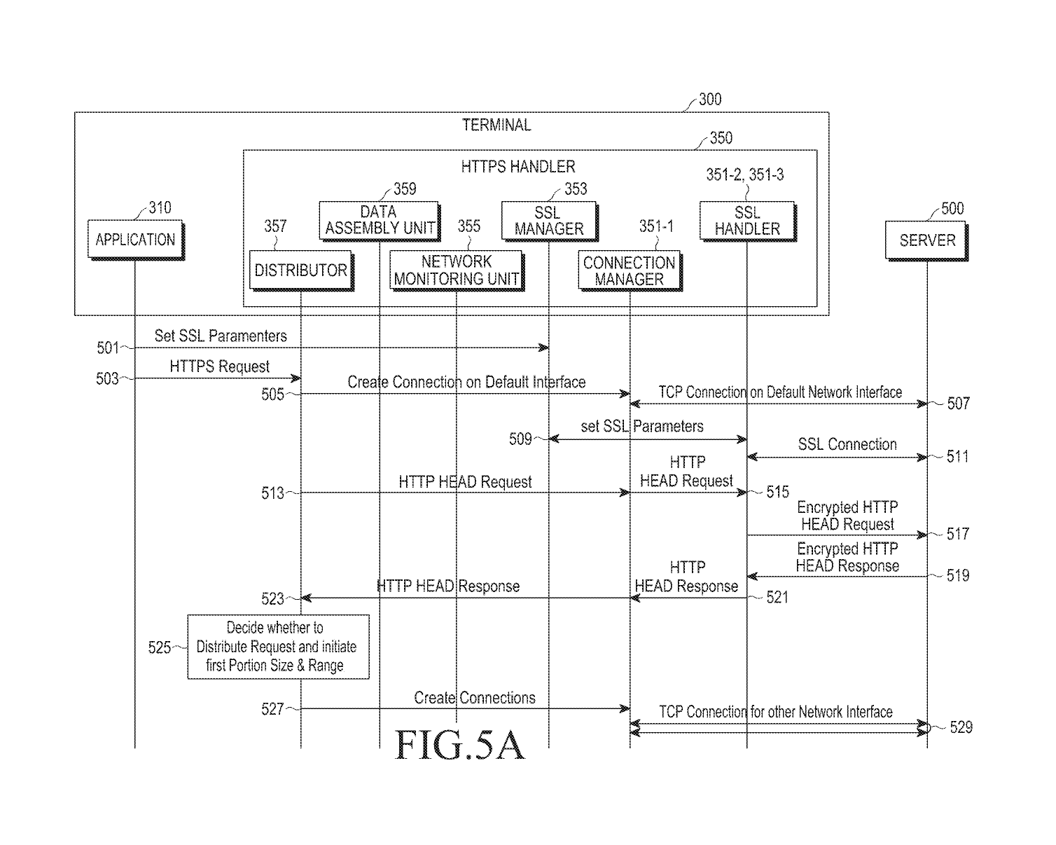

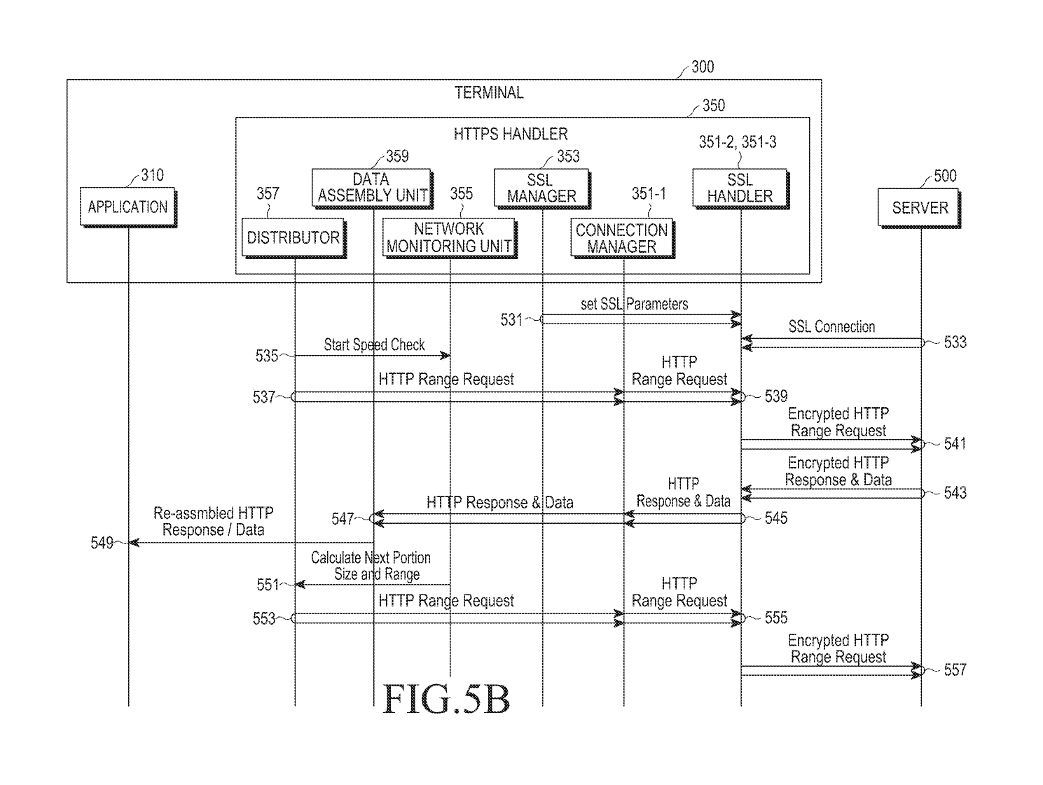

FIGS. 5A and 5B are flowcharts illustrating a method of distributing traffic using a plurality of network interfaces in a wireless communication system according to various embodiments of the present disclosure.

Referring to FIGS. 5A and 5B, two lines drawn in operations (for example, operations 529, 531, 533, 537 to 547, and 553 to 557) may represent that a plurality of network interfaces are used.

Before the current embodiment is described, an HTTP HEAD request and an HTTP RANGE request that are used in the embodiment of FIGS. 5A and 5B among HTTP requests defined in HTTP standards will be first described below.

The HTTP HEAD request is used to request transmission of information, like an HTTP GET request. However, while the HTTP GET request is used to request transmission of service data (for example, content) corresponding to a uniform resource locator (URL), the HTTP HEAD request is used to request transmission of information about the service data. Meanwhile, the HTTP RANGE request is used to request distributive transmission of service data. The amount and range of service data that is distributively transmitted through an SSL connection of each network interface is indicated in the HTTP RANGE request. In the current embodiment of the present disclosure, the terminal 300 may transmit the HTTP HEAD request to the server 500, and receive information about a data amount of the corresponding content from the server 500, as an HTTP HEAD response. In addition, the terminal 300 may transmit an HTTP RANGE request indicating at least one of a data amount and range of content that is to be distributively transmitted to each network interface, to the server 500, and receive content distributively transmitted from the server 500 through the corresponding network interface.

More specifically, if the application 310 is executed and a request for downloading content is received, the application 310 may set SSL-related information for downloading the content, in operation 501. First, the application 310 may transfer the set SSL-related information to the SSL manager 353, and the SSL manager 353 may store the received SSL-related information.

In operation 503, the application 310 may transfer an HTTPS request for secured downloading of the content to the distributor 357.

In operation 505, the distributor 357 may receive the HTTPS request, and request the connection manager 351-1 to generate a connection through a default network interface. The default network interface may be the first network interface 331. If the first network interface 331 is, for example, a Wi-Fi network interface, the second network interface 333 may be a cellular network interface. According to another example, if the first network interface 331 is a cellular network interface, the second network interface 333 may be a Wi-Fi network interface.

In operation 507, the connection manager 351-1 may generate a TCP connection through the first network interface 331.

In operation 509, the SSL manager 353 may set SSL parameters for the first network interface 331 based on the SSL-related information.

In operation 511, the SSL handler 351-2 may generate an SSL connection to the server 500 through the first network interface 331. If the SSL connection is generated, the distributor 357 may transmit an HTTP HEAD request to the connection manager 351-1 to request the connection manager 351-1 to transmit information about the content in order to determine a data amount of the content, in operation 513.

In operations 515 to 523, the connection manager 351-1 may transfer the HTTP HEAD request to the first SSL handler 351-2, and the first SSL handler 351-2 may encrypt the HTTP HEAD request to the server 500 through the first network interface 331. The server 500 may transmit an HTTP HEAD response including the data amount of the content to the terminal 300, and the HTTP HEAD response may be transferred to the distributor 357 via the first network interface 331, the first SSL handler 351-2, and the connection manager 351-1.

In operation 525, the distributor 357 may determine whether to distribute traffic of the content to the second network interface 333, based on the information about the data amount of the content included in the HTTP HEAD response. If the distributor 357 determines that traffic of the content should be distributed, the distributor 357 may decide an amount and range of the content that are to be distributed to the first and second network interfaces 331 and 333, that is, to be distributively transmitted from the server 500.

In operation 527, the distributor 357 may request the connection manager 351-1 to generate a TCP connection through the second network interface 333.

In operation 529, the connection manager 351-1 may request the server 500 to generate a TCP connection through the second network interface 333 so that TCP connections through both the first and second network interfaces 331 and 333 are generated, since a TCP connection through the first network interface 331 has already been generated in the operation 507.

In operation 531, referring to FIG. 5B, the SSL manager 353 may set SSL parameters for the second network interface 333, based on the SSL-related information.

In operation 533, the second SSL handler 351-3 may generate an SSL connection to the server 500 through the second network interface 333.

In operation 535, the distributor 357 may request the network monitoring unit 355 to detect download speeds of the content at the first and second network interfaces 331 and 333. Operation of detecting download speeds may be performed periodically or based on network load. In the current embodiment of the present disclosure, the terminal 300 may control download amounts and download speeds through the first and second network interfaces 331 and 333, based on the detected download speeds.

For example, in operation 537, the distributor 357 may transmit an HTTP RANGE request to the connection manager 351-1, in order to adjust amounts and ranges of the content to be distributively transmitted through the SSL connections of the first and second network interfaces 331 and 333, based on the download speeds detected in operation 535.

In operations 539 to 547, the connection manager 351-1 may transfer the received HTTP RANGE request to the first and second SSL handlers 351-1 and 351-2. The first and second SSL handlers 351-1 and 351-2 may encrypt the HTTP RANGE request, and transmit the encrypted HTTP RANGE request to the server 500 through the first and second network interfaces 331 and 333. The server 500 may adjust amounts and ranges of the content to be distributively transmitted through the respective SSL connections, according to the HTTP RANGE request, and transmit an HTTP RANGE response through the respective SSL connections. The HTTP RANGE response and data of the content adjusted, encrypted, and transmitted according to the HTTP RANGE request may be transferred to the data assembly unit 359 via the first and second network interfaces 331 and 333, the first and second SSL handler 351-2 and 351-3, and the connection manager 351-1, sequentially. At this time, the first and second SSL handlers 351-2 and 351-3 may decrypt the encrypted data of the content and the encrypted HTTP RANGE response.

In operation 549, the data assembly unit 359 may re-assemble the data of the content distributively received through the first and second network interfaces 331 and 333 to original data, and transfer the original data to the application 310 together with the HTTP RANGE response.

Operations 551 to 557 of transmitting an HTTP RANGE request for the next part of the content to be transmitted are the same as operations 535 to 541 described above.

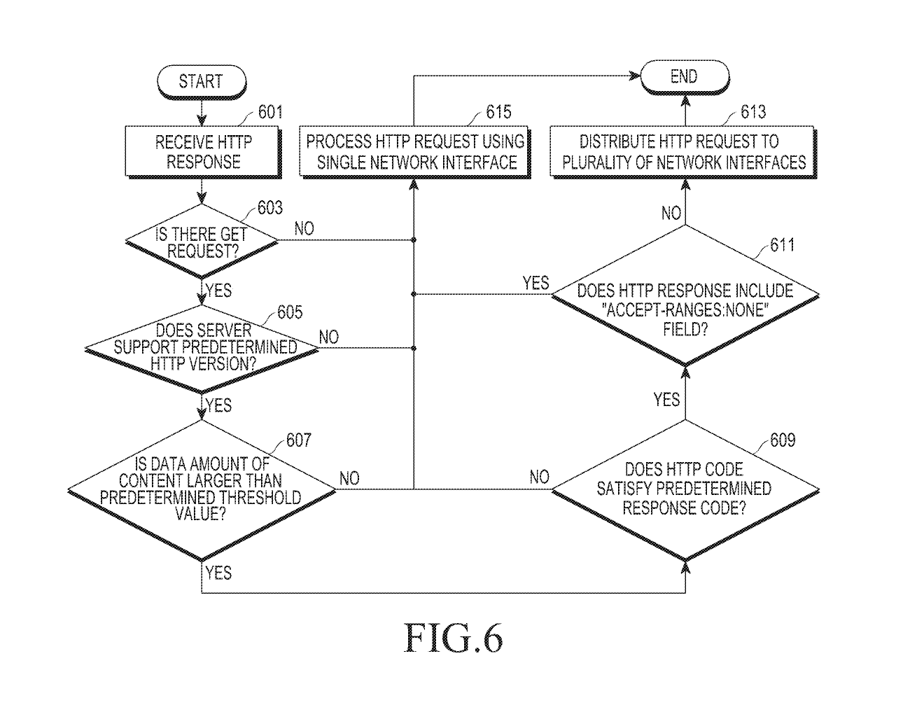

FIG. 6 is a flowchart illustrating a method of enabling a terminal to determine whether to use a plurality of network interfaces in a wireless communication system according to an embodiment of the present disclosure. The method of FIG. 6 corresponds to an example of operation 525 of FIG. 5A.

Referring to FIG. 6, after an HTTPS request is received from the application 310, the distributor 357 may receive an HTTP response (also, referred to as an HTTP HEAD response) including information about a data amount of the corresponding content from the server 500, in operation 601.

In operation 603, the distributor 357 may determine whether the HTTPS request is a GET request defined in the HTTP standards.

If the distributor 357 determines that the HTTPS request is a GET request, the distributor 357 may determine whether the server 500 supports an HTTP version (for example, HTTP 1.1 version), in operation 605.

If the distributor 357 determines that the server 500 supports the HTTP version, the distributor 357 may determine whether the data amount of the content is greater than a threshold value, in operation 607.

If the distributor 357 determines that the data amount of the content is greater than the threshold value, the distributor 357 may determine whether an HTTP code included in the HTTP HEAD response received from the server 500 satisfies a response code, in operation 609. For example, the response code may be “200 OK” or “206 for partial content” defined in the HTTP standards.

If the distributor 357 determines that the HTTP code satisfies the response code, the distributor 357 may determine whether the HTTP HEAD response includes a “Accept-Ranges:None” field, in operation 611.

If the distributor 357 determines that the HTTP HEAD response does not include the “Accept-Ranges:None” field, the distributor 357 may determine that the server 500 supports an HTTP RANGE request, and perform operation for distributing traffic to a plurality of network interfaces, in operation 613.

Meanwhile, if the distributor 357 determines that any one of operations 603, 605, 607, or 609 is not satisfied or determines in operation 611 that the HTTP HEAD response includes the “Accept-Ranges:None” field, the distributor 357 may request the connection manager 351-1 to download the content through a single network interface (for example, a default network interface), similar to the method of the related art, in operation 615.

According to the embodiments of the present disclosure as described above, since the terminal can download HTTPS-based content using the plurality of network interfaces, the terminal can further improve content download performance by downloading HTTPS-based content simultaneously through the plurality of network interfaces without changing an existing application.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. A method for operating a terminal in a communication system, the method comprising:
generating a first secure sockets layer (SSL) connection through a first network interface with a server that provides content based on hypertext transfer protocol security (HTTPS) if an HTTPS request is received from an application;
generating a second SSL connection through a second network interface with the server; and
receiving data transmitted through the first SSL connection and the second SSL connection from the server, through the first network interface and the second network interface.

2. The method of claim 1, wherein the first SSL connection and the second SSL connection are generated based on SSL-related information provided from the application.

3. The method of claim 1, wherein the generating of the second SSL connection is performed if a data amount of the content is greater than a threshold value.

4. The method of claim 1, wherein the generating of the second SSL connection further comprises:
receiving information about a data amount of the content from the server; and
generating the second SSL connection if the data amount of the content is greater than the threshold value.

5. The method of claim 1, further comprising adjusting at least one of a data amount and a range of the content that is to be distributively transmitted through the first SSL connection and the second SSL connection, based on download speeds through the first network interface and the second network interface.

6. The method of claim 5, wherein the adjusting of the at least one of the data amount and the range of the content further comprises:
monitoring download speeds of the first network interface and the second network interface respectively;
determining at least one of a data amount and a range of the content that is to be distributively transmitted, based on the monitored download speeds; and
transmitting an HTTP RANGE request including the at least one of the data amount and the range of the content, to the server.

7. The method of claim 1, wherein the first SSL connection and the second SSL connection are generated through different SSL handlers respectively corresponding to the first SSL connection and the second SSL connection.

8. The method of claim 1, further comprising re-assembling the distributively-transmitted data of the content received through the first network interface and the second network interface to original data.

9. The method of claim 1, wherein the first network interface and the second network interface are different network, and each of the first network interface and the second network interface is one of a Wi-Fi network and a cellular network.

10. The method of claim 1, wherein data encrypted by the terminal and the server based on SSL parameters is transmitted/received through the first SSL connection and the second SSL connection.

11. A terminal for distributing traffic in a wireless communication system, the terminal comprising:
a controller configured to:
generate a first secure sockets layer (SSL) connection through a first network interface with a server that provides content based on hypertext transfer protocol security (HTTPS) if an HTTPS request is received from an application,
generate a second SSL connection through a second network interface with the server based on information about the content, and
receive data that is transmitted through the first SSL connection and the second SSL connection from the server, through the first network interface and the second network interface; and
a receiver configured to receive the data in a network.

12. The terminal of claim 11, wherein the controller is further configured to generate the first SSL connection and the second SSL connection, based on SSL-related information provided from the application.

13. The terminal of claim 11, wherein the controller is further configured to generate the second SSL connection, based on information about a data amount of the content.

14. The terminal of claim 11, wherein the controller is further configured to generate the second SSL connection if a data amount of the content is greater than a threshold value.

15. The terminal of claim 11, wherein the controller is further configured to adjust at least one of a data amount and a range of the content that is to be distributively transmitted through the first SSL connection and the second SSL connection, based on download speeds through the first network interface and the second network interface.

16. The terminal of claim 15, wherein the controller is further configured to:
monitor download speeds of the first network interface and the second network interface respectively,
determine at least one of a data amount and a range of the content that is to be distributively transmitted, based on the monitored download speeds, and
transmit an HTTP RANGE request including the at least one of the data amount and the range of the content, to the server.

17. The terminal of claim 11, wherein the controller is further configured to generate the first SSL connection and the second SSL connection through different SSL handlers respectively corresponding to the first SSL connection and the second SSL connection.

18. The terminal of claim 11, wherein the controller is further configured to re-assemble the distributively-transmitted data of the content received through the first network interface and the second network interface to original data.

19. The terminal of claim 11, wherein data encrypted by the terminal and the server based on SSL parameters is transmitted/received through the first SSL connection and the second SSL connection.

20. The method of claim 1, wherein the second SSL connection is generated based on information about a data amount of the content.
